(19) United States
(12) Patent Application Publication
(10) Pub. No.: US 2024/0281545 A1
(43) Pub. Date: Aug. 22, 2024

(54) SYSTEM AND METHOD FOR SECURE DATA MESSAGING

(71) Applicant: MPOWERED TECHNOLOGY SOLUTIONS INC., Aurora (CA)

(72) Inventors: Joel Roberto SOTOMAYOR, Aurora (CA); John Corrie SLOOT, Waterloo (CA); Meng TIAN, Markham (CA)

(21) Appl. No.: 18/293,484

(22) PCT Filed: Jul. 29, 2022
(86) PCT No.: PCT/CA2022/051171

§ 371 Date: Jan. 30, 2024

Related U.S. Application Data
(60) Provisional application No. 63/227,627, filed on Jul. 30, 2021.
(60) Provisional application No. 63/327,138, filed on Apr. 4, 2022.

(51) Int. Cl. G06F 21/60

(52) U.S. Cl. CPC G06F 21/606

(57) ABSTRACT

Systems and methods of generating and processing one-time pads (OTPs) for use in secure communication are provided. The systems comprise a processor and a memory storing instructions which when executed by the processor configure the processor to perform the methods. One method comprises generating a set of OTPs, seeding an Internet of Things (IoT) device with the OTPs, and securely providing a copy of the OTPs to a receiving server that will receive communications from the IoT device encrypted with the OTPs. Another method comprises generating a payload for a message packet, determining a hash of the payload, encrypting the hash and the payload using one of a set of OTPs stored in a memory of the IoT device, inserting before the payload an identifier associated with the one of the OTPs and the hash of the payload, and transmitting the message packet to the receiving server.

### CROSS-REFERENCE

This application is related to and claims priority to U.S. Application No. 63/227,627, entitled SYSTEM AND METHOD FOR SECURE DATA MESSAGING, and filed Jul. 30, 2021.

This application is also related to and claims priority to U.S. Application No. 63/327,138, entitled SYSTEM AND METHOD FOR SECURE DATA MESSAGING, and filed Apr. 4, 2022.

### FIELD

The present disclosure generally relates to secure messaging, and in particular to a system and method for secure data messaging.

### INTRODUCTION

Bespoke real-time IoT sensors may be created to overcome lack of security between messages between IoT sensors and a central hub. There are few security protocols involved in how the data is transported from an IoT device to a base station. While the data packets may be sent using modern technology such as Bluetooth Low Energy (BLE5), the security infrastructure in the data transport layer is not very robust.

### SUMMARY

In accordance with an aspect, there is provided a method of generating one-time pads (OTPs) for use in secure communication. The method comprises generating a set of OTPs, seeding an Internet of Things (IoT) device with the OTPs, and securely providing a copy of the OTPs to a receiving server that will receive communications from the IoT device encrypted (using XOR) with the OTPs.

In accordance with another aspect, there is provided a system for generating one-time pads (OTPs) for use in secure communication. The systems comprise a processor and a memory storing instructions which when executed by the processor configure the processor to generate a payload for a message packet, determine a hash of the payload, encrypt the hash and the payload using one of a set of OTPs stored in a memory of the IoT device, insert before the payload an identifier associated with the one of the OTPs and the hash of the payload, and transmit the message packet to the receiving server.

In accordance with another aspect, there is provided a method of securely sending message packets from an IoT device to a receiving server. The method comprises generating a payload for a message packet, determining a hash of the payload, encrypting the hash and the payload using one of a set of OTPs stored in memory of the IoT device, inserting before the payload an identifier associated with the one of the OTPs and the hash of the payload, and transmitting the message packet to the receiving server.

In accordance with another aspect, there is provided an IoT device comprising a processor and a memory. The memory stores a plurality of one-time pads. The memory also stores instructions which when executed by the process configure the processor to generate a payload for a message packet, determine a hash of the payload; encrypt the hash and the payload using one of a set of OTPs stored in a memory of the IoT device, insert before the payload an identifier associated with the one of the OTPs and the hash of the payload, and transmit the message packet to the receiving server.

In accordance with another aspect, there is provided a method of securely receiving packets at a receiving sever from an IoT device. The method comprises receiving a packet from the IoT device, and rejecting the packet if an identifier associated with the packet is not located in a memory housing one-time pad (OTP) identifiers.

In accordance with another aspect, there is provided a system for securely receiving packets at a receiving sever from an IoT device. The system comprises a processor and a memory storing instructions which when executed by the processor configure the processor to receive a packet from the IoT device, and reject the packet if an identifier associated with the packet is not located in a memory housing OTP identifiers.

In accordance with another aspect, there is provided another method of securely receiving packets at a receiving sever from an IoT device. The method comprises receiving a packet from the IoT device, determining that an identifier associated with the packet is located in a memory housing OTP identifiers, decrypting the packet using a OTP associated with the identifier, determining a hash of a payload resulting from the decrypting of the packet, and rejecting the packet if the hash of the payload does not match a hash value in the decrypted packet.

In accordance with another aspect, there is provided another system for securely receiving packets at a receiving sever from an IoT device. The system comprises a processor and a memory storing instructions which when executed by the processor configure the processor to receive a packet from the IoT device, determine that an identifier associated with the packet is located in a memory housing OTP identifiers, decrypt the packet using a OTP associated with the identifier, determine a hash of a payload resulting from the decrypting of the packet, and reject the packet if the hash of the payload does not match a hash value in the decrypted packet.

In accordance with another aspect, there is provided another method of securely receiving packets at a receiving sever from an IoT device. The method comprises receiving a packet from the IoT device, determining that an identifier associated with the packet is located in a memory housing OTP identifiers, decrypting the packet using a OTP associated with the identifier, determining a hash of a payload resulting from the decrypting of the packet, determining that the packet if the hash of the payload matches a hash value in the decrypted packet, and sending the payload to be processed.

In accordance with another aspect, there is provided another system for securely receiving packets at a receiving sever from an IoT device. The system comprises a processor and a memory storing instructions which when executed by the processor configure the processor to receive a packet from the IoT device, determine that an identifier associated with the packet is located in a memory housing OTP identifiers, decrypt the packet using a OTP associated with the identifier, determine a hash of a payload resulting from the decrypting of the packet, determine that the packet if the hash of the payload matches a hash value in the decrypted packet, and send the payload to be processed.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

Embodiments will be described, by way of example only, with reference to the attached figures, wherein in the figures:

FIG. 1 illustrates, in a diagram, an example of a system of generating shared OTPs, in accordance with some embodiments;

FIG. 2 illustrates, in a flowchart, an example of a method of generating OTPs, in accordance with some embodiments;

FIG. 3 illustrates, in a system flow diagram, an example of a method of secure communication between an IoT device and a server, in accordance with some embodiments;

FIG. 4 illustrates, in a flowchart, an example of a method of securing sending data, in accordance with some embodiments;

FIG. 5 illustrates an example of IoT device data payload characteristics, in accordance with some embodiments;

FIG. 6 illustrates, in a flowchart, an example of a method of securing receiving data, in accordance with some embodiments;

FIG. 7 illustrates an example of a TLS handshake;

FIG. 8 illustrates an example of how the OTP method mitigates replay attacks, in accordance with some embodiments;

FIG. 9 illustrates an example of how the OTP method mitigates man in the middle attacks, in accordance with some embodiments; and

FIG. 10 is a schematic diagram of a computing device such as a server.

It is understood that throughout the description and figures, like features are identified by like reference numerals.

### DETAILED DESCRIPTION

Embodiments of methods, systems, and apparatus are described through reference to the drawings. Applicant notes that the described embodiments and examples are illustrative and non-limiting. Practical implementation of the features may incorporate a combination of some or all of the aspects, and features described herein should not be taken as indications of future or existing product plans.

In some embodiments, a refactored and improved system and method of provisioning one-time pads (OTPs), also known as Vernam-ciphers, is provided. A one-time pad (OTP) is a mathematically unbreakable encryption method. Even with infinite computational power and infinite time this encryption cannot be broken. However, OTP does have limitations that impedes its implementation. The teachings herein provide a novel technical solution that mitigates OTP's limitations which have been hampering its widespread adoption and use, and allow for OTP to be used in a wide variety of use cases.

In some embodiments, such new novel processes may be incorporated into the manufacturing of hardware sensors to ensure a high level of security. A purpose-built OTP architecture into the manufacturing of sensors allows for sensor data to be sent via other means rather than through standard (e.g., transport layer security (TLS)) security tunnels or traditional asymmetric encryption—which inherently has unnecessary bandwidth overhead which should be abandoned especially in areas with limited or slow cellular access. In addition, a small data package is required when data is frequently sent in a higher frequency. Furthermore, international cellular Internet of Things (IoT) data transfer rates can be expensive, so the compression of every byte matters to reduce costs.

There are four commonly accepted tenets for OTP to work:
the key must be truly random;
the key must be at least as long as the plaintext;
the key must never not be reused in whole or in part; and
the key must be kept completely secret.

Historically, the practical problems related to OTP included:
making large quantities of random pads took a great deal of time and money;
there was not an easy way to produce truly random numbers, and it was impractical to use natural randomness like radioactivity;
securely distributing the pads was impractical and very cost-prohibitive;
every party has to have identical copies which makes it difficult to scale;
new pads must be issued to all parties simultaneously;
everybody must remain in step, using the correct pad at the correct time; and
if one set of pads is compromised, the whole system is compromised.

In addition, there were also other problems related to most IoT sensors that inhibited using OTP. These included:
IoT devices have limited central processing unit (CPU) power and traditional encryption can be CPU intensive;
international cellular IoT data rates can be expensive per megabite (MB) (in some embodiments, up to $0.40/MB), so every byte counts and it was not cost-effective to send large chunks of data or use security protocols that had a lot of unnecessary data overhead;
most IoT sensors used traditional asymmetric encryption, which has a lot of bandwidth overhead—in some embodiments, up to ten times the size of the payload;
traditional asymmetric encryption may be broken with the advent of the quantum computer; and
IoT devices had a small storage capacity.

However, there have been improvements in IoT sensors such as increased storage capacity in smaller hard drive enclosures, being physically smaller than previous versions, having a price point that could be considered in expensive, and most IoT components are more widely available than ever before. In addition, the ability to produce large quantities of random numbers using an off-the-shelf hardware random number generator is now widely available. Previously, this was slow and arduous, and the mechanisms to create truly random number generators were not really random. The entropy required to produce randomness was not really significant.

In some embodiments, there is provided a system and method for ensuring secure data transmission between an IoT sensor and a server that has been implemented with an OTP security protocol during manufacturing of the IoT sensor. For example, a large number of specifically sized (one-time) pads may be pre-generate. Since existing software or hardware methods to generate random numbers have been shown as not being truly random, in some embodiments, inexpensive Zener diodes may be used to generate truly random numbers and create the (one-time) pads. Reverse biased Zener diodes with ratings greater than approximately 6 volts (V) will randomly conduct current under a process called “avalanche breakdown”. The breakdown delay is a statistical process at which the time between breakdown events cannot be forecasted, and are thus, considered “random”. Due to the quantum nature of this breakdown delay process, Truly Random Numbers for use in generating the OTP-based methods describe herein may be generated using reverse biased Zener diodes.

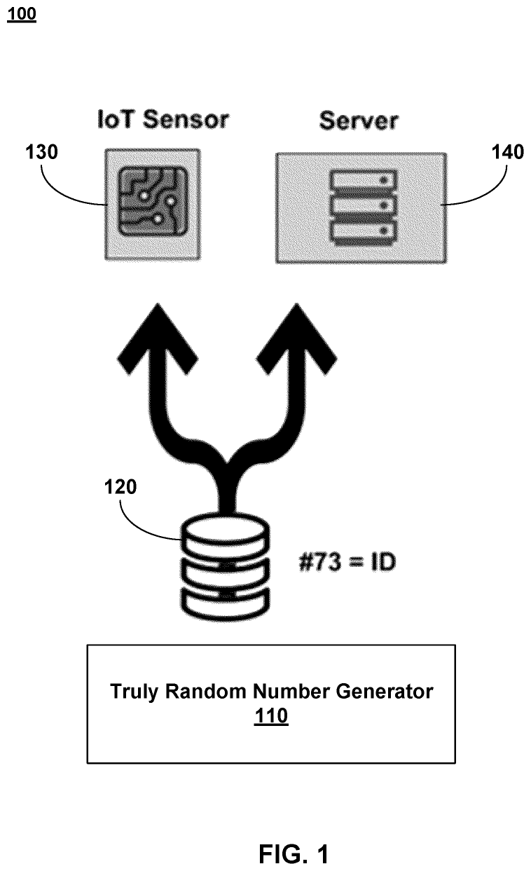

FIG. 1 illustrates, in a diagram, an example of a system of generating shared OTPs 100, in accordance with some embodiments. In some embodiments, the system operates an IoT manufacturing facility. A Truly Random Number Generator 110 may be used to generate one or more keys used for the generation of a set of OTPs. For example, one OTP 120 may have an identifier as #73. Corresponding copies of the OTPs may be stored on both an IoT sensor 130 and a server 140 that will be communicating with the IoT sensor 130. Other components may be added to the system 100.

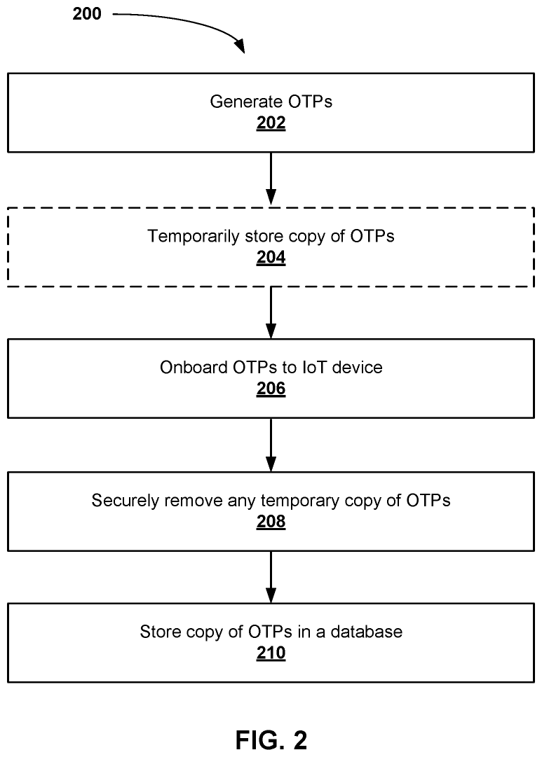

FIG. 2 illustrates, in a flowchart, an example of a method of generating OTPs 200, in accordance with some embodiments. The method may be performed at a manufacturing facility. OTPs may be generated 202 and on-boarded 206 (e.g., seeded, stored) on IoT device. For example, a large number of 1,212 byte random one-time pads may be pre-generated using a Truly Random Number generator 110 that is preferably not software based for security reasons. Optionally, the pre-generated OTPs may be temporarily stored at a receiving station in the manufacturing facility prior to seeding of the IoT device. For security reasons, there will preferably only be one receiving station that stores the OTPs. Before the OTPs are on-boarded 204 with the Truly Random Number Generator, the IoT device may be placed in a Faraday cage for security purposes. Once pads are embedded to the IoT device 204, they may be securely removed from manufacturing facility 206. In some embodiments, the IoT device will store a separate OTP for every transaction it is expected to make. OTPs are distributed upon manufacture and are never transmitted, meaning that there preferably will be a Faraday cage around the IoT device during manufacturing. In some embodiments, the Faraday cage may be a room in the manufacturing facility where the IoT devices are manufactured. The OTPs will be assigned a unique identifier (id) and a copy will be stored 208 in a database associated with a receiving device, station or server to which the IoT device is to securely communication using the OTPs. In some embodiments, a memory (such as a memory stick or other memory device) may be sent to the database operator to secure transfer the copy of the OTPs to the database.

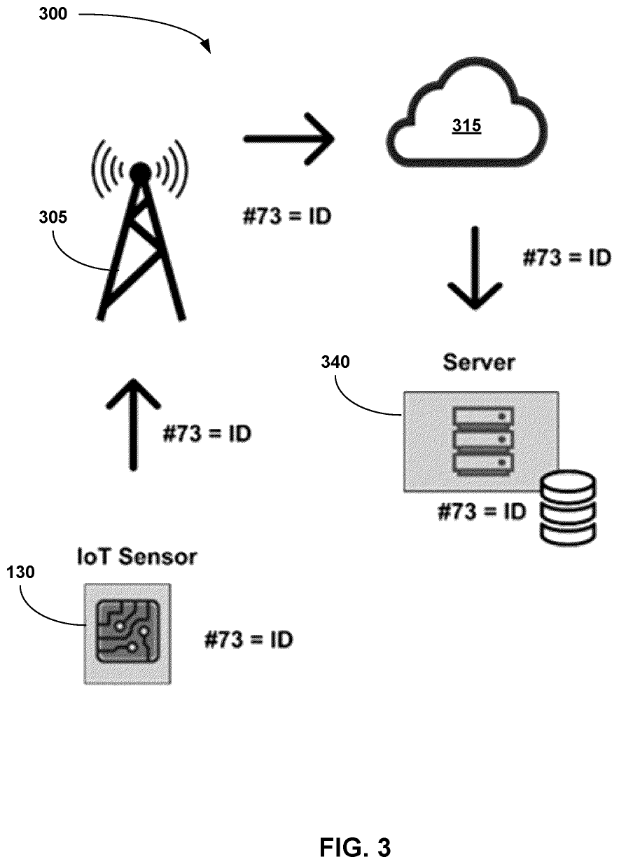

FIG. 3 illustrates, in a system flow diagram, an example of a method of secure communication between an IoT device and a server 300, in accordance with some embodiments. The IoT sensor 130 may send a communication to a receiving station or receiving server 340. The communication may be sent over-the-air via base station 305 via cloud network 315. In other embodiments, the IoT sensor 130 may simply communicate via Bluetooth™ or other short or medium range wireless communication technology to a receiving server 340. The communication may be secured using a OTP 120 (e.g., OTP with identifier #73). Other steps may be added to the method 300, such as deleting or marking that the OTP was used so that it will not be used to secure any subsequent communication.

In some embodiments, a OTP will be removed from the database (or marked as having been used or marked as not to be used) immediately after being consumed (i.e., after receiving and decrypting a communication received from the IoT device that was encrypted using that OTP. In some embodiments, the OTPs will also be hashed prior to the “seeding” of the IoT device. This hash will ensure that the data was not compromised. For example, prior to any OTP being used, the IoT device may be checked against its hash. If the check fails, the (one-time) pad has been compromise, and the next OTP will be used instead. In some embodiments, upon the creation of each OTP, a cryptographic hash of the pad is calculated and is stored alongside it. Each time a pad is used, either on the IoT device or the server, the hash of the OTP is calculated and checked. If the hashes do not match, the pad is rejected and a signal is sent to the AI/ML algorithm. This is done to detect any corruption of OTPs.

A failure of an OTP being used will signal that there might be some rogue activity, and that the IoT device may have been compromised. The ability to quickly and automatically identify orphan OTPs may be performed via an artificial intelligence (AI)/machine learning (ML) algorithm to ensure the integrity of the system. In some embodiments, an AI/ML subsystem may monitor all transactions, considering variables such as the identifier (id), id sequence, rate of transmission, size of the transmission, time of day, any hash failures, etc. When an anomaly is detected, corrective action may be taken, such as performing a systems check, blocking certain traffic, and/or sending a notification to an administrator.

The OTP process can be used to replace any standard communication encryption (e.g., transport layer security (TLS)) as long as the two communicating devices can be in the same physical space at one point in time to onboard the OTPs in both the IoT device (data distributor) and the server (data receiver). This will most likely occur at the manufacturing facility, but OTPs can be securely communicated in other manners. The OTP process can also be used to authenticate either device with the other since there is a mapping from the pad identifier (id) to the device, and thus, the OTP cannot come from another device.

In some embodiments, these OTPs may be stored at the manufacturing facility and a receiving station (or receiving server) only. Once the OTP is integrated into an IoT device, the OTPs may be securely deleted from the manufacturing facility, and/or securely transferred to a receiving station or server that will be in communication with the IoT device. The IoT device may store an embedded OTP for every transaction that it will ever make. Due to the memory size required to store an OTP, the lifespan of an IoT device may be limited (e.g., to 365 days).

### Sample Calculation

In some embodiments, the total memory size for an IoT device to store one year's worth of OTPs can be calculated by equation 1:

$$Total Size = maximum ( Max ) packets per day \times 365 days \times Max packet size \qquad ( 1 )$$

For example, if an IoT device is assumed to use 480 packets per day (i.e., one packet every 3 minutes), and a maximum size for each packet is set to be approximately 1,212 bytes per packet (the size of the transmission for that IoT device), then the total memory size required to store one year's worth of OTPs would be 203 MB:

$$\begin{matrix}Total Size = maximum ( Max ) packets per day \times 365 days \times Max packet size \\ = 480 packets per day \times 365 days \times 1 , 212 bytes per packet \\ = 175 , 200 packets \times 1 , 212 bytes per packet \\ = 212 , 342 , 400 bytes \\ = 203 MB\end{matrix}$$

Thus, assuming that an IoT sensor sends one 1,212 byte sized packet every 3 minutes, it will transmit a maximum of 203 MB per year. Therefore, each IoT device in this scenario would need to store at least 203 MB of one-time pads per year.

In some embodiments, a Bill of Materials (BOM) of the sensor components may be stored using a distributed ledger technology (e.g., blockchain). Using a distributed ledger technology will enhance provenance and traceability. This is desirable because if there are problems with a sensor not functioning properly, the parts that were used for that particular build may be identified, and forensically analysed to identify the root cause of the problem.

In some embodiments, a single user diagram protocol (UDP) packet may be sent over Internet Protocol version 6 (IPv6) for every data transaction. Only when the packet is decrypted using the appropriate pad on the server will the transaction be considered “valid” and the data stored in a database. In addition, the number of pads left in the database of the IoT device may be programmatically added to provide the owner of the sensor a warning before the pads are used up. To further strengthen the security of the OTP system, a sequential order of when one-time pads can be used may be created. This way it can be ensured that the correct one-time pad can only be used at the correct time, and misalignment of one-time pad use will trigger that the IoT device or receiving device has been compromised and that there has been a security breach. In some embodiments, a protocol may be used to generate the order of OTPs.

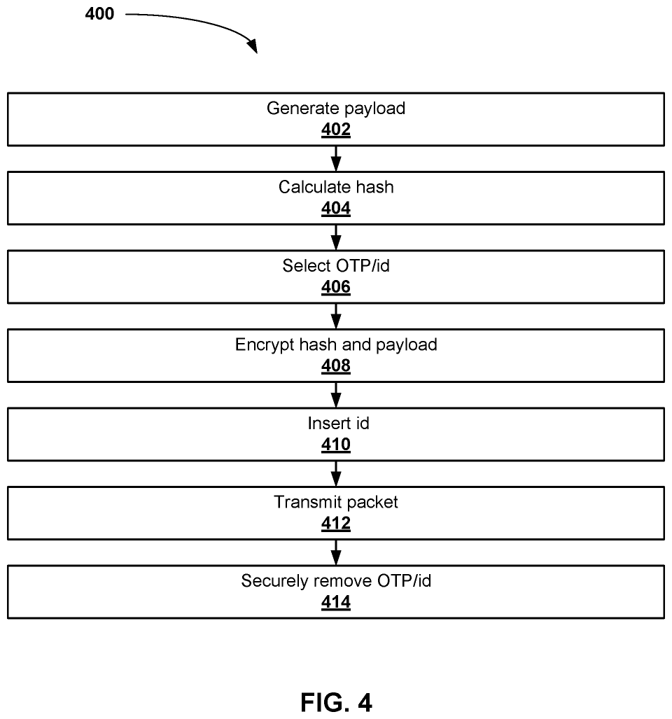

Referring to FIGS. 4 to 8, an exemplary process will now be described showing how an IoT device sends data securely to a server and how a server receives that data payload.

### IoT Device

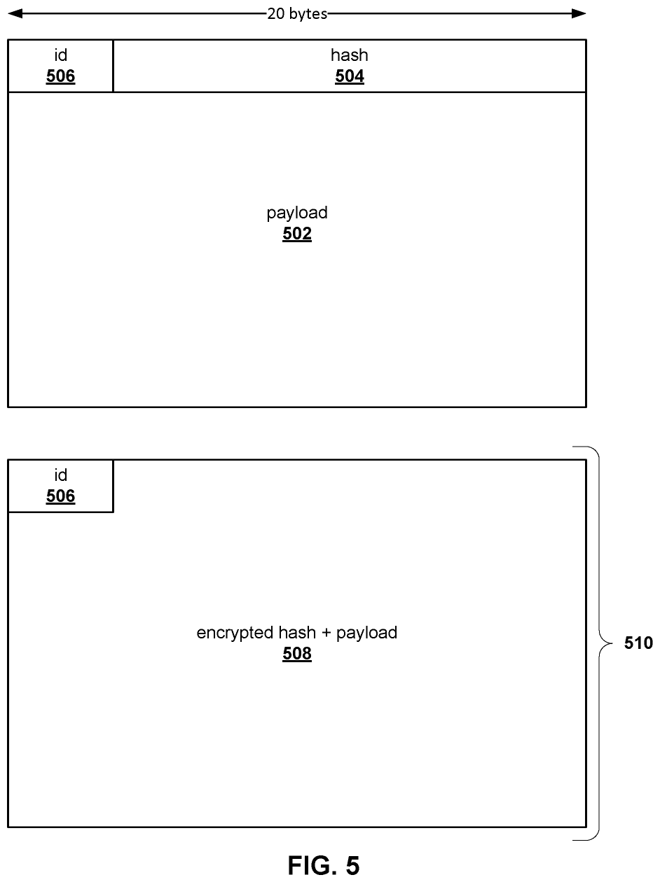

FIG. 4 illustrates, in a flowchart, an example of a method of securely sending data 400, in accordance with some embodiments. The method 400 may be performed by a data process embedded in a memory of the IoT device 120. A payload 502 (e.g., message payload 502 as shown in FIG. 5) is created 402. Next, a hash 504 of the payload 402 is calculated 404. This may be performed automatically using a secure cryptographic hash algorithm. An OTP/id combination is selected from a local database 406 associated with the IoT device. In some embodiments, a next OTP/id combination in a predetermined list stored on the IoT device memory may be selected. In some embodiments, a protocol may be used to selected an OTP/id from a listing of available OTP/id combinations, or to reorder the OTP/id combinations in a determined order. The determined order and/or the protocol may be stored in the device IoT memory. The OTP is used to encrypt the hash and payload 408 (see 508 of FIG. 5). The id 506 may be placed at beginning of packet (or at any predefined location of the packet) 410. The packet 510 is transmitted 412. FIG. 5 illustrates an example of IoT device data payload characteristics, in accordance with some embodiments. In some embodiments, the id 506 and hash 504 may be 20 bytes in length. A packet (e.g., id 506, hash 504 and payload 502) may transformed into a secured packet (e.g., id 506 and encrypted hash/payload 508). In the example shown in FIG. 5, the packet 510 that is actually transmitted comprises the id 506 and encrypted hash+payload combination 508. The OTP/id combination option is securely removed from database 414 (or marked as used or marked as not to be used) so that the OTP/id combination is not used in another communication by the IoT device. Other steps may be added to the method 400.

### Decryption Server

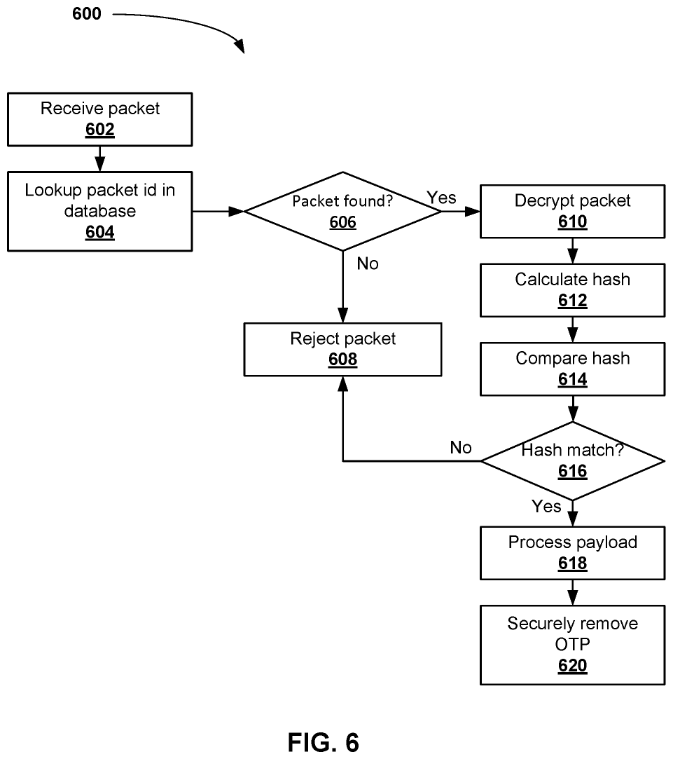

FIG. 6 illustrates, in a flowchart, an example of a method of securely receiving data 600, in accordance with some embodiments. The method 600 may be performed by the receiving station or receiving server 340. A data packet 510 is received 602. The first four (4) bytes (or any other predefined number of bytes) may be parsed to provide the id 506 to be used in a local database lookup 604. If the id 506 is not found 606, then the packet 510 is rejected 608, and optionally sent to the detection subsystem (e.g., AI/ML algorithm) for a security check where the transaction may be logged and flagged using the AI/ML algorithm in order to identify the root cause of the failed transaction. Otherwise 606, the corresponding OTP is used to decrypt 610 the packet 510 (excluding the ID). A hash of the payload 502 is calculated 612. The calculated hash is compared 614 to the transmitted hash 508. If they do not match 616, then the packet 510 is rejected 608, and optionally sent to AI/ML for the security check where the transaction will be logged and flagged using the AI/ML algorithm in order to identify the root cause of the failed transaction. Otherwise 616, the payload 502 is sent to the processing server to be processed 618. The OTP may then be securely removed 620 from the database. Other steps may be added to the method 600.

### Processing Server

In some embodiments, once the data payload 502 has been authenticated, the data payload 502 may be processed or sent to a server for processing, and transaction data may be logged for reporting and auditing purposes.

### Data Payload Savings by Using OTP Based Encryption Method

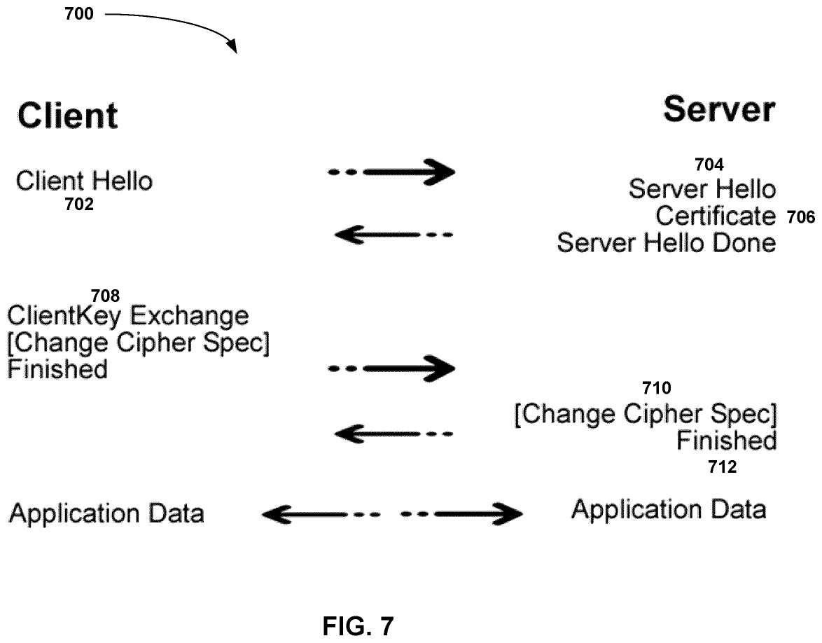

FIG. 7 illustrates an example of a TLS handshake 700. In some embodiments, the average size of a ClientHello message 702 is about 160 to 170 bytes. It will vary based on the number of ciphersuites sent by the client as well as how many TLS ClientHello extensions are present. If session resumption is used, another 32 bytes are added for the Session ID field. The ServerHello message 704 is a bit more static than the ClientHello message 702, but still variable in size due to TLS extensions. In some embodiments, the average size is 70 to 75 bytes. The Certificate message 706 varies the most in size between different servers. The message 706 carries the certificate of the server, as well as all intermediate issuer certificates in the certificate chain (minus the root cert). Since certificate sizes vary quite a bit based on the parameters and keys used, an average of 1500 bytes may be used per certificate (self-signed certificates can be as small as 800 bytes). Another varying factor is the length of the certificate chain up to the root certificate. In some embodiments, there are four (4) certificates in the chain. Overall, this totals approximately six kiloBytes (6 kB) for this example message.

Typically, the ClientKeyExchange message 708 may be a Rivest-Shamir-Adleman (RSA) server certificate. This corresponds to size of 130 bytes for this message 708. The ChangeCipherSpec message 710 (technically not a handshake message) has a fixed size of 1 byte. The size of the Finished message 712, depending whether secure sockets layer (SSL) version (v) 3 (SSLv3) is used or TLS, may vary from 36 and 12 bytes respectively. Since many implementations support TLSv1.0 at least, the sample calculation assumes TLS will be used and therefore the size will be 12 bytes. It should be understood that predetermine sizes may be used in the calculation, including the largest typical size for any type of message.

With an average size of each message exchanged, the average handshake size may be calculated. The messages exchanged have TLS Record header for each record sent (5 bytes), as well as TLS Handshake header (4 bytes). The most common case can be simplified such that each arrow in the handshake diagram 700 is a TLS Record: 4 Records exchanged for total of 20 bytes. Each message has the handshake header (except the ChangeCipherSpec one), and so seven times the Handshake header for total of 28 bytes.

In the example described herein of a packet sized 1,212 bytes being sent every 3 minutes, the total overhead to establish a standard TLS session comes to approximately 6.5 kilobytes (kB) on average:

$$20 ( four Records ) + 28 ( 7 Handshake header ) + 170 ( ClientHello ) + 75 ( ServerHello ) + 6 , 000 ( four Certiicate ) + 130 ( RSA server certificate ) + 2 \times 1 ( two Cipher Spec ) + 2 \times 12 ( two Finished ) = 6 , 449 bytes$$

In some embodiments, using the above methods, there is only 20 bytes of overhead per packet (e.g., four bytes for the OTP id and 16 bytes for the hash). The methods also require less central processing unit (CPU) resources, and therefore less power, extending battery lifespan of an IoT device.

It should be understood that the average sizes noted above in the sample calculation may vary. The OTP may be sized according to the expected usage of the IoT device. In some embodiments, the OTP size may be bespoke for a particular purpose. In other embodiments, the OTP size may be estimated using an average or largest possible size for any component in the messaging protocol.

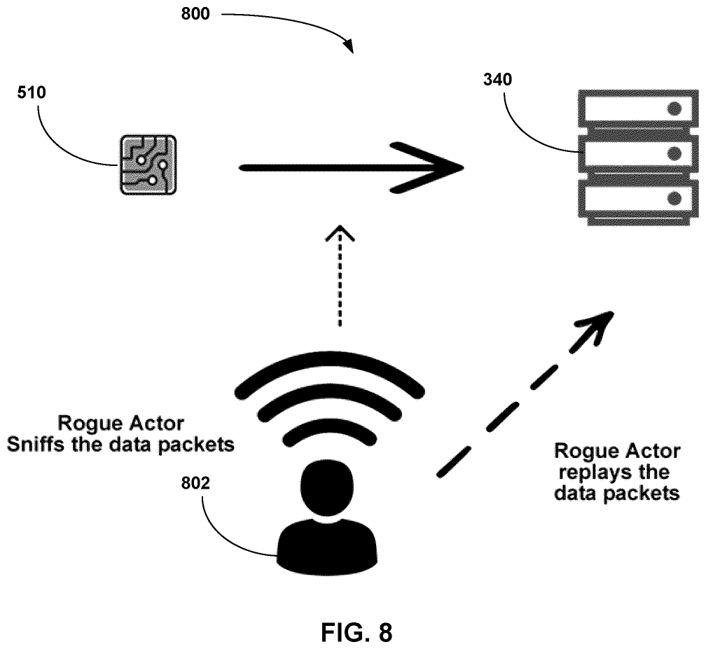

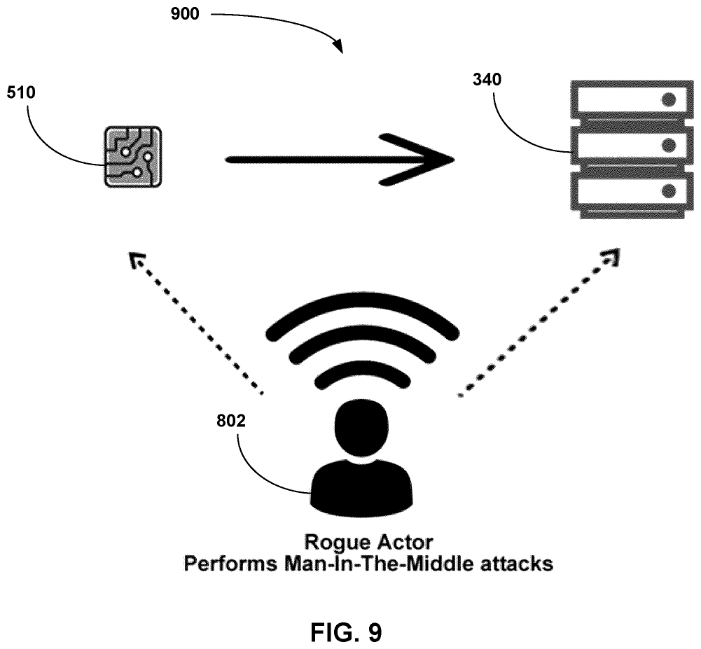

The encryption methods described herein are considered quantum-safe because they do not rely on an asynchronous method of key generation. The OTPs are synchronously shared between sender (IoT device/sensor 130) and recipient (receiving server 340). Referring to FIGS. 8 and 9, how the above teachings handle common attacks will be described.

### Replay Attack

FIG. 8 illustrates an example of how the OTP method mitigates replay attacks 800, in accordance with some embodiments. If an attacker 802 (e.g., rogue actor who sniffs the data packets) re-sends a compromised data packet (e.g., rogue actor who replays the data packets), the compromised data packet will be rejected because its id will have been removed from the database. The above OTP encryption method 400 prevents Replay Attacks from occurring because of the checks and balances of the system to never reuse an OTP once it has been used. In addition, the sequence of the OTP use will also help identify if an IoT device may have been compromised. For example, in some embodiments, if an OTP id is presented out of sequence, then the system will know there is an anomaly to investigate. For security reasons, ids should not be sent in numeric order. This would be detectable as a pattern by a cryptanalyst. Instead, a random sequence should be generated that both the server and IoT device agree upon. If a packet is sent out of sequence, this could indicate that one or more have been lost and should be deleted.

### Man-In-the-Middle Attack

FIG. 9 illustrates an example of how the OTP method mitigates man in the middle attacks 900, in accordance with some embodiments. If an attacker 802 intercepts and modifies the id of the packet, it will either be not found, and rejected, or a different pad will be used to decrypt and the resulting hash will be different. If an attacker modifies any other part of the packet, the resulting hash will not match in the decryption process, and the packet may be rejected. Thus, man-in-the-middle attack vectors are circumvented/thwarted.

### Securely Removing OTPs

In some embodiments, once an OTP has been used, the OTP data repositories (e.g., data structure or databases) in the IoT device and receiving server will “zeroed out” the OTP (e.g., replacing the bits representing the OTP with zeros), thus securely and permanently deleting that OTP. The id and the hash may be kept for logging purposes. This prevents someone from recovering deleted OTPs by potentially examining the database file. The operating system and storage device may be configured in such a way that old data will not remain in storage.

In other embodiments, the IoT database may mark consumed OTPs as “consumed” or “not to be used” in order that they are not reused by the IoT device. In other embodiments, the receiving server may mark the OTPs as “consumed” to identify packets using invalid identifiers.

### Replacement of OTPs

In some embodiments, the IoT device will be supplied with enough OTPs for its entire life cycle. If, for example, an IoT has a non-replaceable battery with a one-year charge, the device would need at least a one-year supply of OTPs. For example, if the number of OTPs are generated and stored for one year's worth of communications, then the power supply of the IoT device may last one year. This will allow for efficient provisioning of power supply to the IoT devices. Moreover, when the IoT device is getting low on OTPs, a process may be established where a replacement IoT device is sent to replace the ageing IoT device, and a memory (e.g., a memory stick) may be sent to the receiving server 340 operator to install the replacement IoT device OTPs. In some embodiments, the server database may track OTP usage for IoT devices, and signal that a replacement IoT device is required to be sent once the number of OTP reaches a certain level.

The protocol for the above replacement method may be set to start using the first OTP of the new IoT device once all OTPs of the previous IoT device have been consumed. Alternatively, once the receiving server 340 detects that the first new OTP is being used, the server 340 may then know that a new IoT device is being used and simply securely delete all remaining OTPs from the previous IoT device.

In some embodiments, the IoT device that is being replaced may be reused by sending the used IoT device to the manufacturer to be “refurbished” with new OTPs.

In some embodiments, a communication device securely connected to the IoT device or any other device may be used to process and transmit packets using the OPTs processes described herein.

### Encrypted Remote Backup Using OTP

In some embodiments, a blank hard disk manufacturer could fill the entire disk with one-time pads (OTP). As the disk fills with files, the OTPs may be read from the disk and used to securely transmit the new files to a backup server maintained by the hard disk manufacturer. As the disk fills, the number of OTPs diminish until the disk is full and no more backups can be made.

As an example, a user purchases the hard disk from a manufacturer. They install the OTP solution described herein, and add a 1 megabyte (MB) image to it. Before writing the image to the disk, the OTP is read from that spot on the disk and put into memory. The image is written to the disk. Then, either immediately or at a later time, the image is ready from the disk, mixed with the OTP and transmitted to the manufacturer's central server. When it is received, it is decrypted with the only other copy of the OTP and written to the backup disk.

The OTP solution may be implemented into an existing encryption framework such as OpenSSH. Therefore, when performed properly as described herein, an existing backup infrastructure can still be utilized using OTP instead of standard asymmetric encryption.

### Secure Quantum-Proof VPN Using OTP Patent

Typical commercial virtual private network (VPN) services essentially tunnel all of a user's internet traffic through their servers to mask the user's location and provide privacy from the user's Internet service provider (ISP). The traffic is encrypted using standard asymmetric encryption. Various governments and hacker groups may be collecting and storing this encrypted data now in the hope that they will be able to unlock it at some point in the future.

In some embodiments, a manner in which to defeat this “harvest now and decrypt later” strategy is to use OTPs.

In some embodiments, a VPN service may be developed where a user is physically mailed a USB stick (or other storage device) that contains (e.g., many terabytes of) OTPs. When the user inserts the USB (or couples the other storage device), everything is configured for them. All of their internet traffic is then piped through the VPN service servers using the OTPs. Once the OTPs are depleted, their service ends (for example, they may be given a warning when the number of OTPs reach a small number). The user can then return the USB (or other storage device) and the VPN service may physically mail the user a new storage device (e.g., USB stick). In some embodiments, such a VPN service may save on hardware costs by reusing the physical storage devices (e.g., USB sticks).

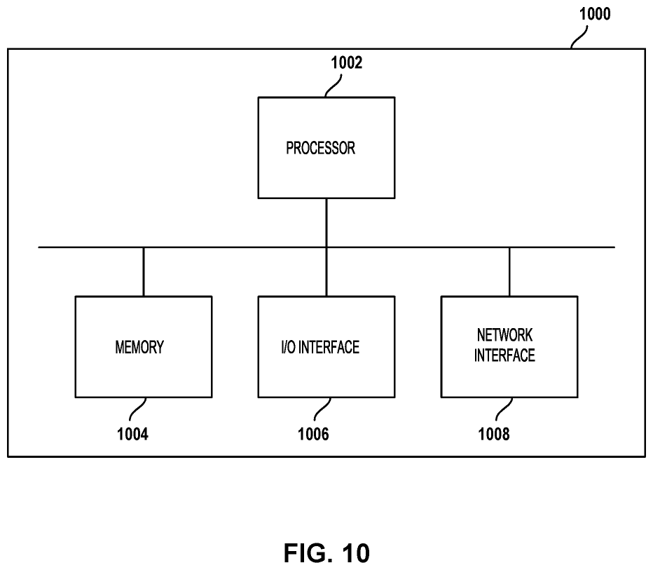

FIG. 10 is a schematic diagram of a computing device 1000 such as a server. As depicted, the computing device includes at least one processor 1002, memory 1004, at least one I/O interface 1006, and at least one network interface 1008.

Processor 1002 may be an Intel or AMD x86 or x64, PowerPC, ARM processor, or the like. Memory 1004 may include a suitable combination of computer memory that is located either internally or externally such as, for example, random-access memory (RAM), read-only memory (ROM), compact disc read-only memory (CDROM).

Each I/O interface 1006 enables computing device 1000 to interconnect with one or more input devices, such as a keyboard, mouse, camera, touch screen and a microphone, or with one or more output devices such as a display screen and a speaker.

Each network interface 1008 enables computing device 1000 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others.

The foregoing discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification.

As can be understood, the examples described above and illustrated are intended to be exemplary only.

1. A method of generating one-time pads (OTPs) for use in secure communication, the method comprising:
generating, by a manufacturing server, a set of OTPs;
seeding, by the manufacturing server, an Internet of Things (IoT) device with the OTPs; and
securely providing, by the manufacturing server, a copy of the OTPs to a receiving server that will receive communications from the IoT device encrypted with the OTPs.

2. The method as claimed in claim 1, wherein the IoT device is one of:
an IoT sensor; or
an IoT communication device securely connectable to the IoT device.

3. The method as claimed in claim 1, wherein the IoT device is placed in a Faraday cage when seeded with the OTPs.

4. The method as claimed in claim 1, comprising securely storing, by the manufacturing server, the copy of the OTPs in a memory device, wherein the receiving server is securely connected to the memory device when the receiving server receives the OTPs.

5. The method as claimed in claim 1, wherein the seeding of the IoT device with OTPs comprises storing the OTPs in a memory of the IoT device.

6. The method as claimed in claim 1, comprising:
storing, by the manufacturing server, a hash function on a memory of the IoT device; and
storing, by the manufacturing server, the hash function on a memory of the receiving server.

7. The method as claimed in claim 1, comprising at least one of:
storing a temporary copy of the OTPs in a manufacturing memory prior to seeding the IoT device; or
securely removing the temporary copy of the OTPs from the manufacturing memory after the seeding of the IoT device.

8. The method as claimed in claim 1, comprising:
receiving, by the manufacturing server, a connection to a used IoT device;
securely deleting, by the manufacturing server, any OTPs stored in the memory of the used IoT device; and
generating new OTPs for the used IoT device.

9. A system for generating one-time pads (OTPs) for use in secure communication, the system comprising:
a processor; and
a memory storing instructions which when executed by the process configure the processor to:
generate a set of OTPs;
seed an Internet of Things (IoT) device with the OTPs; and
securely provide a copy of the OTPs to a receiving server that will receive communications from the IoT device encrypted with the OTPs.

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. The method as claimed in claim 1, comprising securely sending message packets from the IoT device to the receiving server, securely sending comprising:
generating, by the IoT device, a payload for a message packet;
determining, by the IoT device, a hash of the payload;
encrypting, by the IoT device, the hash and the payload using one of a set of one-time pads (OTPs) stored in a memory of the IoT device;
inserting before the payload, by the IoT device:
an identifier associated with the one of the OTPs; and
the hash of the payload; and
transmitting, by the IoT device, the message packet to the receiving server.

24. The method as claimed in claim 1, comprising at least one of:
securely receiving packets at the receiving sever from the IoT device, wherein said securely receiving comprises:
receiving, by the receiving server, a packet from the IoT device; and
rejecting, by the receiving server, the packet if an identifier associated with the packet is not located in a memory housing one-time pad (OTP) identifiers;
securely receiving packets at the receiving sever from the IoT device, wherein said securely receiving comprising:
receiving, by the receiving server, a packet from the IoT device;
determining, by the receiving server, that an identifier associated with the packet is located in a memory housing one-time pad (OTP) identifiers;
decrypting, by the receiving server, the packet using a OTP associated with the identifier;
determining, by the receiving server, a hash of a payload resulting from the decrypting of the packet; and
rejecting, by the receiving server, the packet if the hash of the payload does not match a hash value in the decrypted packet; or
securely receiving packets at the receiving sever from the IoT device, said securely receiving comprising:
receiving, by the receiving server, a packet from the IoT device;
determining, by the receiving server, that an identifier associated with the packet is located in a memory housing one-time pad (OTP) identifiers;
decrypting, by the receiving server, the packet using a OTP associated with the identifier;
determining, by the receiving server, a hash of a payload resulting from the decrypting of the packet;
determining, by the receiving server, that the packet of the hash of the payload matches a hash value in the decrypted packet; and
sending, by the receiving server, the payload to be processed.

25. The system as claimed in claim 9, wherein the IoT device is one of:
an IoT sensor; or
an IoT communication device securely connectable to the IoT device.

26. The system as claimed in claim 9, wherein the IoT device is placed in a Faraday cage when seeded with the OTPs.

27. The system as claimed in claim 9, wherein:
the processor is configured to securely store the copy of the OTPs in a memory device; and
the receiving server is securely connected to the memory device when the receiving server receives the OTPs.

28. The system as claimed in claim 9, wherein to seed the IoT device with OTPs the processor is configured to store the OTPs in a memory of the IoT device.

29. The system as claimed in claim 9, wherein the processor is configured to:
store a hash function on a memory of the IoT device; and
store the hash function on a memory of the receiving server.

30. The system as claimed in claim 9, wherein the processor is configured to at least one of:
store a temporary copy of the OTPs in a manufacturing memory prior to seeding the IoT device; or
securely remove the temporary copy of the OTPs from the manufacturing memory after the seeding of the IoT device.

31. The system as claimed in claim 9, wherein the processor is configured to:
receive a connection to a used IoT device;
securely delete any OTPs stored in the memory of the used IoT device; and
generate new OTPs for the used IoT device.

32. The system as claimed in claim 9, wherein the IoT device is configured to securely sending message packets from the IoT device to the receiving server, the IoT device configured to:
generate a payload for a message packet;
determine a hash of the payload;
encrypt the hash and the payload using one of a set of one-time pads (OTPs) stored in a memory of the IoT device;
inserting before the payload, by the IoT device:
an identifier associated with the one of the OTPs; and
the hash of the payload; and
transmitting, by the IoT device, the message packet to the receiving server.

33. The system as claimed in claim 9, wherein the receiving device is configured to at least one of:
securely receive packets from the IoT device, the receiving device configured to:
receive a packet from the IoT device; and
reject the packet if an identifier associated with the packet is not located in a memory housing one-time pad (OTP) identifiers;
securely receiving packets from the IoT device, wherein the receiving device is configured to:
receive a packet from the IoT device;
determine that an identifier associated with the packet is located in a memory housing one-time pad (OTP) identifiers;
decrypt the packet using a OTP associated with the identifier;
determine a hash of a payload resulting from the decrypting of the packet; and
reject the packet if the hash of the payload does not match a hash value in the decrypted packet; or
securely receive packets from the IoT device, the receiving server configured to:
receive a packet from the IoT device;
determine that an identifier associated with the packet is located in a memory housing one-time pad (OTP) identifiers;
decrypt the packet using a OTP associated with the identifier;
determine a hash of a payload resulting from the decrypting of the packet;
determine that the packet of the hash of the payload matches a hash value in the decrypted packet; and
send the payload to be processed.
